(19) United States
(12) Patent Application Publication
(10) Pub. No.: US 2021/0332268 A1
(43) Pub. Date: Oct. 28, 2021

(54) REINFORCING PLATE ADHESIVE LAYER STRUCTURE, STRUCTURE OF SCREEN BENDING REGION, AND DISPLAY SCREEN

(71) Applicant: WUHAN CHINA STAR OPTOELECTRONICS SEMICONDUCTOR DISPLAY TECHNOLOGY CO., LTD., Wuhan, Hubei (CN)

(72) Inventor: Cuilin ZHU, Wuhan, Hubei (CN)

(21) Appl. No.: 16/624,033

(22) PCT Filed: Oct. 16, 2019
(86) PCT No.: PCT/CN2019/111381

§ 371 Date: Dec. 18, 2019

(30) Foreign Application Priority Data
Jun. 26, 2019 (CN) 201910562491.1

(51) Int. Cl. C09J 7/25; B32B 7/12; B32B 3/02; B32B 27/06; B32B 27/36; C09J 7/38

(52) U.S. Cl. CPC C09J 7/255; B32B 7/12; B32B 3/02; B32B 27/06; B32B 27/36; C09J 2203/318; B32B 2457/20; C09J 2467/006; C09J 2301/124; C09J 2301/302; C09J 7/38

(57) ABSTRACT

A reinforcing plate adhesive layer structure, a structure of a screen bending region, and a display screen are provided. The reinforcing plate adhesive layer structure is a three-layer structure. A top layer of the three-layer structure is a first viscous adhesive layer, a middle layer of the three-layer structure is a hard plate layer, and a bottom layer of the three-layer structure is a second viscous adhesive layer. The first and the second viscous adhesive layers are segmentation structures, a first viscous material is adopted on both ends of the first and the second viscous adhesive layers, a second viscous material is adopted on the middles of the first and the second viscous adhesive layers.

### FIELD OF INVENTION

The present disclosure relates to the field of display technology, and particularly relates to a reinforcing plate adhesive layer structure, a structure of a screen bending region, and a display screen.

### BACKGROUND OF INVENTION

Currently, intelligent consumer electronic industries are in a stage of rapid development, with consumers increasingly favoring electronic products with high technical content, so requirements to innovativeness of electronic products are becoming higher. In recent years, the concept of mobile phones with foldable screens has been gaining popularity and is gradually being attached high importance by big vendors, becoming a direction of development of future smart phones.

In modern communication industries, market demand of products such as mobile phones, televisions, tablets, notebooks, digital cameras, and the like is growing, and various display devices are also being developed to be bendable. In manufacturing of flexible full screen display modules, it is inevitable and necessary to use bending technology.

Now, products are designed after bending processes. If quality of a bending region is unsatisfactory, the products need to be disassembled. Because bending and reinforcing plate adhesive has strong viscosity, after disassembling, it will cause serious damage to metal wires and make the products unable to rework, thereby reducing utilization rate of the products.

Reinforcing plate adhesive layer structure in prior art has a problem in that the bending and reinforcing plate adhesive has great viscosity, which, after disassembling, will cause serious damage to metal wires and make the products unable to rework, thereby reducing utilization rate of the products.

### SUMMARY OF INVENTION

In order to solve the technical problem mentioned above, the present disclosure provides a reinforcing plate adhesive layer structure, a structure of a screen bending region, and a display screen.

A reinforcing plate adhesive layer structure is provided. The reinforcing plate adhesive layer structure is a three-layer structure. A top layer of the three-layer structure is a first viscous adhesive layer, a middle layer of the three-layer structure is a hard plate layer, and a bottom layer of the three-layer structure is a second viscous adhesive layer.

Furthermore, the first viscous adhesive layer is a segmentation structure, the first viscous material is adopted on both ends of the first viscous adhesive layer, the second viscous material is adopted on a middle of the first viscous adhesive layer. Furthermore, viscosity of the first viscous material is greater than viscosity of the second viscous material.

According to the reinforcing plate adhesive layer structure provided by an embodiment of the present disclosure, the middle layer of the reinforcing plate adhesive layer structure is a hard polyethylene terephthalate (PET) material.

According to the reinforcing plate adhesive layer structure provided by an embodiment of the present disclosure, a pressure sensitive adhesive material is adopted on both ends the first viscous adhesive layer and the second viscous adhesive layer, hard PET material is adopted on the middles of the first viscous adhesive layer and the second viscous adhesive layer.

According to the reinforcing plate adhesive layer structure provided by an embodiment of the present disclosure, a pressure sensitive adhesive material is adopted on both ends the first viscous adhesive layer and the second viscous adhesive layer, the second viscous material is adopted on the middles of the first viscous adhesive layer and the second viscous adhesive layer.

According to the reinforcing plate adhesive layer structure provided by an embodiment of the present disclosure, pressure sensitive adhesive materials are spaced apart from each other on the first viscous adhesive layer and the second viscous adhesive layer, the second viscous material is disposed between the pressure sensitive adhesive materials.

According to the reinforcing plate adhesive layer structure provided by an embodiment of the present disclosure, a heat sensitive adhesive material is adopted on both ends and the middles of the first viscous adhesive layer and the second viscous adhesive layer.

An embodiment of the present disclosure further provides a structure of a screen bending region. The screen bending region includes a first back plate, a second back plate, and a reinforcing plate adhesive layer structure. The reinforcing plate adhesive layer structure is disposed between the first back plate and the second back plate.

Furthermore, the reinforcing plate adhesive layer structure is a three-layer structure, a top layer of the three-layer structure is a first viscous adhesive layer, a middle layer of the three-layer structure is a hard plate layer, and a bottom layer of the three-layer structure is a second viscous adhesive layer.

Furthermore, the first viscous adhesive layer is a segmentation structure, a first viscous material is adopted on both ends of the first viscous adhesive layer, a second viscous material is adopted on a middle of the first viscous adhesive layer.

Furthermore, the second viscous adhesive layer is a segmentation structure, the first viscous material is adopted on both ends of the second viscous adhesive layer, the second viscous material is adopted on a middle of the second viscous adhesive layer. Furthermore, viscosity of the first viscous material is greater than viscosity of the second viscous material. Furthermore, viscosity of the first viscous material is greater than viscosity of the second viscous material.

According to the structure of the screen bending region provided by an embodiment of the present disclosure, the structure of the screen bending region further includes a first panel, a bending region, a second panel, and a metal wire. The first panel is connected to the second panel by the bending region. The first back plate is disposed under the first panel. The second back plate is disposed under the second panel. After the bending region is bent, the second back plate and the first back plate are bonded together by the reinforcing plate adhesive layer structure.

According to the structure of the screen bending region provided by an embodiment of the present disclosure, the metal wire penetrates the first panel, the bending region, and the second panel.

According to the structure of the screen bending region provided by an embodiment of the present disclosure, the middle layer of the reinforcing plate adhesive layer structure is a hard polyethylene terephthalate (PET) material.

According to the structure of the screen bending region provided by an embodiment of the present disclosure, a pressure sensitive adhesive material is adopted on both ends the first viscous adhesive layer and the second viscous adhesive layer, hard PET material is adopted on the middles of the first viscous adhesive layer and the second viscous adhesive layer.

According to the structure of the screen bending region provided by an embodiment of the present disclosure, a pressure sensitive adhesive material is adopted on both ends the first viscous adhesive layer and the second viscous adhesive layer, and the second viscous material is adopted on the middles of the first viscous adhesive layer and the second viscous adhesive layer.

According to the structure of the screen bending region provided by an embodiment of the present disclosure, pressure sensitive adhesive materials are spaced apart from each other on the first viscous adhesive layer and the second viscous adhesive layer, the second viscous material is disposed between the pressure sensitive adhesive materials.

According to the structure of the screen bending region provided by an embodiment of the present disclosure, a heat sensitive adhesive material is adopted on both ends and the middles of the first viscous adhesive layer and the second viscous adhesive layer.

An embodiment of the present disclosure further provides a display screen, including a structure of a screen bending region, the structure of the screen bending region including a first back plate, a second back plate, and a reinforcing plate adhesive layer structure, wherein the reinforcing plate adhesive layer structure is disposed between the first back plate and the second back plate.

Furthermore, the reinforcing plate adhesive layer structure is a three-layer structure, a top layer of the three-layer structure is a first viscous adhesive layer, a middle layer of the three-layer structure is a hard plate layer, and a bottom layer of the three-layer structure is a second viscous adhesive layer.

Furthermore, the first viscous adhesive layer is a segmentation structure, a first viscous material is adopted on both ends of the first viscous adhesive layer, a second viscous material is adopted on a middle of the first viscous adhesive layer.

Furthermore, the second viscous adhesive layer is a segmentation structure, the first viscous material is adopted on both ends of the second viscous adhesive layer, the second viscous material is adopted on a middle of the second viscous adhesive layer. Furthermore, viscosity of the first viscous material is greater than viscosity of the second viscous material.

According to the display screen provided by an embodiment of the present disclosure, the middle layer of the reinforcing plate adhesive layer structure is a hard polyethylene terephthalate (PET) material.

According to the display screen provided by an embodiment of the present disclosure, a pressure sensitive adhesive material is adopted on both ends the first viscous adhesive layer and the second viscous adhesive layer, a hard PET material is adopted on the middles of the first viscous adhesive layer and the second viscous adhesive layer.

According to the display screen provided by an embodiment of the present disclosure, a pressure sensitive adhesive material is adopted on both ends the first viscous adhesive layer and the second viscous adhesive layer, the second viscous material is adopted on the middles of the first viscous adhesive layer and the second viscous adhesive layer.

According to the display screen provided by an embodiment of the present disclosure, pressure sensitive adhesive materials are spaced apart from each other on the first viscous adhesive layer and the second viscous adhesive layer, the second viscous material is disposed between the pressure sensitive adhesive materials.

According to the display screen provided by an embodiment of the present disclosure, a heat sensitive adhesive material is adopted on both ends and the middles of the first viscous adhesive layer and the second viscous adhesive layer.

The present disclosure provides a new reinforcing plate adhesive layer structure, which adopts a segmentation structure. Adopting a first viscous material on both ends of a viscous adhesive layer of the reinforcing plate adhesive, and adopting a second viscous material or polyethylene terephthalate (PET) with no viscosity on a middle of the first viscous adhesive layer, hence during dissembling a bending region, it is easy to separate a second back plate region and the reinforcing plate adhesive layer structure, and the reinforcing plate adhesive layer structure can be removed, which prevents a risk of new fragmentation of circuits of the bending region and improves a yield of repairing of products.

### DESCRIPTION OF DRAWINGS

FIG. 1 is a structural schematic diagram of a reinforcing plate adhesive layer structure provided by an embodiment of the present disclosure.

FIG. 2 is designed schematic diagrams of the reinforcing plate adhesive layer structure provided by an embodiment of the present disclosure.

FIG. 3 is a schematic diagram of bending of a structure of a screen bending region provided by an embodiment of the present disclosure.

### DETAILED DESCRIPTION OF PREFERRED EMBODIMENTS

The descriptions of embodiments below refer to accompanying drawings in order to illustrate certain embodiments which the present disclosure can implement.

In order to allow the above and other purposes, features, and advantages of the present disclosure to be more obvious and easier to understand, preferred embodiments of the present disclosure will be particularly described hereinafter, and with reference to the accompanying drawings, a detailed description will be given below. Moreover, the directional terms of which the present disclosure mentions, for example, “upper”, “lower”, “top”, “bottom”, “front”, “rear”, “left”, “right”, “inside”, “outside”, “side”, “circumference”, “center”, “horizontal”, “vertical”, “axial”, “radial”, “top layer”, “bottom layer”, etc., only refer to directions of the accompanying figures. Therefore, the used directional terms are for illustrating and understanding the present disclosure, but not for limiting the present disclosure.

In the figures, units with similar structures are indicated by the same reference numerals.

The present disclosure aims at addressing designs of current products, that is, after bending processes, if quality of a bending region is unsatisfactory and the products need to be disassembled, because bending reinforcing plate layer structure has strong viscosity, after disassembling, it will cause serious damage to metal wires and make the products unable to rework. The embodiments can solve this defect.

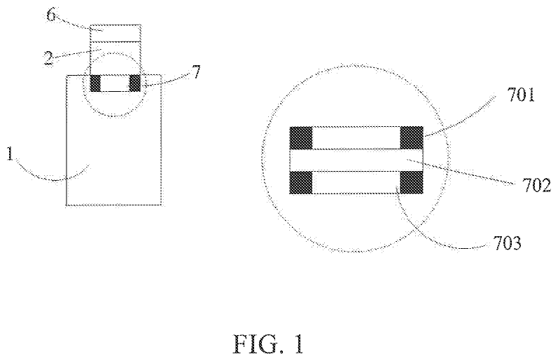

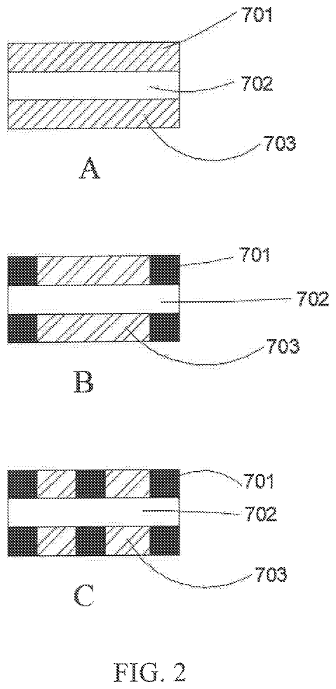

Illustrated in FIG. 1 is a structural schematic diagram of a reinforcing plate adhesive layer structure 7 provided by an embodiment of the present disclosure, From FIG. 2, it can be understood that the reinforcing plate adhesive layer structure 7 is a three-layer structure, a top layer of the three-layer structure is a first viscous adhesive layer 701, a middle layer of the three-layer structure is a hard plate layer 702, and a bottom layer of the three-layer structure is a second viscous adhesive layer 703. Furthermore, the first viscous adhesive layer 701 is a segmentation structure, a first viscous material is adopted on both ends of the first viscous adhesive layer 701, a second viscous material is adopted on a middle of the first viscous adhesive layer; the second viscous adhesive layer 703 is a segmentation structure, a first viscous material is adopted on both ends of the second viscous adhesive layer 703, and the second viscous material is adopted on a middle of the second viscous adhesive layer. Furthermore, the first viscous material is a material with strong viscosity, and the second viscous material is a material with weak viscosity. The viscosity of the first viscous material is greater than the viscosity of the second viscous material. In this embodiment, a hard polyethylene terephthalate (PET) material is adopted on the hard plate layer of the middle of the reinforced plate adhesive layer structure 7.

In an embodiment of the present disclosure, making a segmentation structural design on the viscous adhesive layers of reinforcing plate adhesive layer structure 7 reduces contact area of colloid, which can reduce difficulty of disassembling the reinforcing plate adhesive.

As illustrated in FIG. 1, both ends of the first viscous adhesive layer 701 of the reinforcing plate adhesive layer structure 7 provided by an embodiment of the present disclosure is a pressure sensitive adhesive material, and a hard PET material is adopted on the middle of the first viscous adhesive layer. Furthermore, the reinforcing plate adhesive layer structure 7 is designed in a segmentation structure to reduce a bonding area of the adhesive, and is convenient to disassemble the adhesive. The pressure sensitive adhesive material of the reinforcing plate adhesive layer structure 7 can be replaced with a heat sensitive adhesive material which viscosity reduces when heated.

When using the reinforcing plate adhesive layer structure 7 provided by an embodiment of the present disclosure for disassembling in a bending region 2, a second backplate 6 can be easily separated from the reinforcing plate adhesive layer structure 7. Moreover, the reinforcing plate adhesive layer structure 7 can be torn off and reprocessed. Therefore, it can prevent a risk of occurrence of fragmentation of circuits in the bending region 2, thereby improving a yield of repairing of products.

Illustrated in FIG. 2 is a schematic diagram of structural designs of several reinforcing plate adhesive layer structures 7 provided by embodiments of the present disclosure. The structural designs of the reinforcing plate adhesive layer structures 7 provided by embodiments of the present disclosure include but are not limited to the following designs.

Illustrated in part A of FIG. 2 is a structural schematic diagram of another reinforcing plate adhesive layer structure 7 of an embodiment of the present disclosure. The first viscous adhesive layer 701 of the reinforcing plate adhesive layer structure 7 is a heat sensitive adhesive material. The middle layer 702 of the reinforcing plate adhesive layer structure 7 is a hard PET material. The second viscous adhesive layer 703 of the reinforcing plate adhesive layer structure 7 is a heat sensitive adhesive material. Furthermore, when the illustrated heat sensitive adhesive material is heated (a temperature of about 80° C.), viscosity of the heat sensitive adhesive material reduces. Therefore, when the reinforcing plate adhesive is heated to about 80° C. during disassembling, the reinforcing plate adhesive layer structure 7 will fall off.

Illustrated in part B of FIG. 2 is a structural schematic diagram of yet another reinforcing plate adhesive layer structure 7 of an embodiment of the present disclosure. Both ends of the first viscous adhesive layer 701 of the reinforcing plate adhesive layer structure 7 is a pressure sensitive adhesive material, and a middle of it is a second viscous material; the middle layer 702 of the reinforcing plate adhesive layer structure 7 is a hard PET material. Both ends of the second viscous adhesive layer 703 of the reinforcing plate adhesive layer structure 7 is a pressure sensitive adhesive material, and the middle of it is the second viscous material.

Illustrated in part C of FIG. 2 is a structural schematic diagram of yet another reinforcing plate adhesive layer structure 7 of an embodiment of the present disclosure. A pressure sensitive adhesive material and the second viscous material are discretely disposed on the first viscous adhesive layer 701 of the reinforcing plate adhesive layer structure 7. The middle layer 702 of the reinforcing plate adhesive layer structure 7 is a hard PET material. A pressure sensitive adhesive material and the second viscous material are discretely disposed on the second viscous adhesive layer 703 of the reinforcing plate adhesive layer structure 7. Furthermore, the pressure sensitive adhesive materials of the first viscous adhesive layer 701 and the second viscous adhesive layer 703 of the reinforcing plate adhesive layer 7 are spaced apart from each other. A distance of an interval between the pressure sensitive adhesive materials can be even or uneven, that is, the pressure sensitive adhesive materials and the second viscous materials can be discretely disposed.

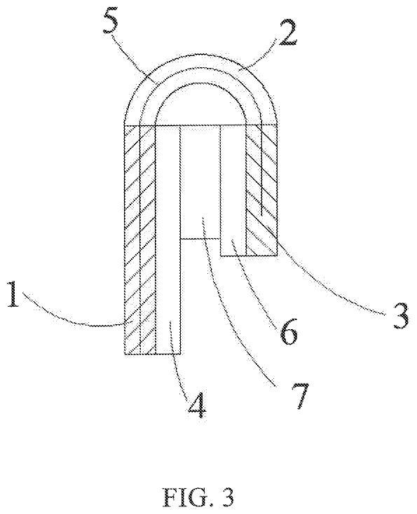

Illustrated in FIG. 3 is a schematic diagram of bending of a structure of a screen bending region provided by an embodiment of the present disclosure. It can be seen from FIG. 3 that the structure of the screen bending region includes a first panel 1, a bending region 2, a second panel 3, a first backplate 4, a metal wire 5, a second backplate 6, and the reinforcing plate adhesive layer structure 7.

Furthermore, the first panel 1 is connected to the second panel 3 by the bending region 2. The first backplate 4 is disposed under the first panel 1, The second backplate 6 is disposed under the second panel 3. After the bending region 2 is bent, the second backplate 6 and the first backplate 4 are bonded together by the reinforcing plate adhesive layer structure 7.

The metal wire 5 penetrates the first panel 1, the bending region 2, and the second panel 3.

The present disclosure further provides a display screen. The structure of the screen bending region provided by an embodiment of the present disclosure is used on the display screen. The screen bending region includes a first backplate 1, a second backplate 3, and a reinforcing plate adhesive layer structure 7. The reinforcing plate adhesive layer structure 7 is disposed between the first backplate 1 and the second backplate 3.

Furthermore, the reinforcing plate adhesive layer structure 7 is a three-layer structure, a top layer of the three-layer structure is a first viscous adhesive layer 701, a middle layer of the three-layer structure is a hard plate layer 702, and a bottom layer of the three-layer structure is a second viscous adhesive layer 703.

Furthermore, the first viscous adhesive layer 701 is a segmentation structure, a first viscous material is adopted on both ends of the first viscous adhesive layer 701, and a second viscous material is adopted on a middle of the first viscous adhesive layer 701.

Furthermore, the second viscous adhesive layer 703 is a segmentation structure, a first viscous material is adopted on both ends of the second viscous adhesive layer 703, and the second viscous material is adopted on a middle of the second viscous adhesive layer 703.

Although the disclosure has been shown and described with respect to one or more implementations, equivalent alterations and modifications will occur to others skilled in the art based upon a reading and understanding of this specification and the annexed drawings. The disclosure includes all such modifications and alterations, and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such features may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

The above are preferred embodiments of the present disclosure. It should be noted that those skilled in the art can further make many changes and modifications without departing from the technical theory of the present disclosure, and the changes and the modifications should be considered as the scope of protection of the present disclosure.

What is claimed is:

1. An reinforcing plate adhesive layer structure, wherein the reinforcing plate adhesive layer structure is a three-layer structure, a top layer of the three-layer structure is a first viscous adhesive layer, a middle layer of the three-layer structure is a hard plate layer, and a bottom layer of the three-layer structure is a second viscous adhesive layer;
wherein the first viscous adhesive layer is a segmentation structure, a first viscous material is adopted on both ends of the first viscous adhesive layer, a second viscous material is adopted on a middle of the first viscous adhesive layer, and wherein a viscosity of the first viscous material is greater than a viscosity of the second viscous material.

2. The reinforcing plate adhesive layer structure as claimed in claim 1, wherein the middle layer of the reinforcing plate adhesive layer structure is a hard polyethylene terephthalate (PET) material.

3. The reinforcing plate adhesive layer structure as claimed in claim 1, wherein a pressure sensitive adhesive material is adopted on both ends the first viscous adhesive layer and the second viscous adhesive layer, and a hard PET material is adopted on the middles of the first viscous adhesive layer and the second viscous adhesive layer.

4. The reinforcing plate adhesive layer structure as claimed in claim 1, wherein a pressure sensitive adhesive material is adopted on both ends the first viscous adhesive layer and the second viscous adhesive layer, and the second viscous material is adopted on the middles of the first viscous adhesive layer and the second viscous adhesive layer.

5. The reinforcing plate adhesive layer structure as claimed in claim 1, wherein pressure sensitive adhesive materials are spaced apart from each other on the first viscous adhesive layer and the second viscous adhesive layer, and the second viscous material is disposed between the pressure sensitive adhesive materials.

6. The reinforcing plate adhesive layer structure as claimed in claim 1, wherein a heat sensitive adhesive material is adopted on both ends and the middles of the first viscous adhesive layer and the second viscous adhesive layer.

7. A structure of a screen bending region, wherein the screen bending region comprises a first backplate, a second backplate, and a reinforcing plate adhesive layer structure, and the reinforcing plate adhesive layer structure is disposed between the first backplate and the second backplate;
wherein the reinforcing plate adhesive layer structure is a three-layer structure, a top layer of the three-layer structure is a first viscous adhesive layer, a middle layer of the three-layer structure is a hard plate layer, and a bottom layer of the three-layer structure is a second viscous adhesive layer;
wherein the first viscous adhesive layer is a segmentation structure, a first viscous material is adopted on both ends of the first viscous adhesive layer, a second viscous material is adopted on a middle of the first viscous adhesive layer;
wherein the second viscous adhesive layer is a segmentation structure, the first viscous material is adopted on both ends of the second viscous adhesive layer, the second viscous material is adopted on a middle of the second viscous adhesive layer, and wherein a viscosity of the first viscous material is greater than a viscosity of the second viscous material.

8. The structure of the screen bending region as claimed in claim 7, wherein the structure of the screen bending region comprises a first panel, a bending region, a second panel, and a metal wire;
wherein the first panel is connected to the second panel by the bending region, the first backplate is disposed under the first panel, the second backplate is disposed under the second panel, and after the bending region is bent, the second backplate and the first backplate are bonded together by the reinforcing plate adhesive layer structure.

9. The structure of the screen bending region as claimed in claim 8, wherein the metal wire penetrates the first panel, the bending region, and the second panel.

10. The structure of the screen bending region as claimed in claim 7, wherein the middle layer of the reinforcing plate adhesive layer structure is a hard polyethylene terephthalate (PET) material.

11. The structure of the screen bending region as claimed in claim 7, wherein a pressure sensitive adhesive material is adopted on both ends the first viscous adhesive layer and the second viscous adhesive layer, and a hard PET material is adopted on the middles of the first viscous adhesive layer and the second viscous adhesive layer.

12. The structure of the screen bending region as claimed in claim 7, wherein a pressure sensitive adhesive material is adopted on both ends the first viscous adhesive layer and the second viscous adhesive layer, and the second viscous material is adopted on the middles of the first viscous adhesive layer and the second viscous adhesive layer.

13. The structure of the screen bending region as claimed in claim 7, wherein pressure sensitive adhesive materials are spaced apart from each other on the first viscous adhesive layer and the second viscous adhesive layer, and the second viscous material is disposed between the pressure sensitive adhesive materials.

14. The structure of the screen bending region as claimed in claim 7, wherein a heat sensitive adhesive material is adopted on both ends and the middles of the first viscous adhesive layer and the second viscous adhesive layer.

15. A display screen, comprising a structure of a screen bending region, the structure of the screen bending region comprising a first backplate, a second backplate, and a reinforcing plate adhesive layer structure, wherein the reinforcing plate adhesive layer structure is disposed between the first backplate and the second backplate;
wherein the reinforcing plate adhesive layer structure is a three-layer structure, a top layer of the three-layer structure is a first viscous adhesive layer, a middle layer of the three-layer structure is a hard plate layer, and a bottom layer of the three-layer structure is a second viscous adhesive layer;
wherein the first viscous adhesive layer is a segmentation structure, a first viscous material is adopted on both ends of the first viscous adhesive layer, and a second viscous material is adopted on a middle of the first viscous adhesive layer;
wherein the second viscous adhesive layer is a segmentation structure, the first viscous material is adopted on both ends of the second viscous adhesive layer, the second viscous material is adopted on a middle of the second viscous adhesive layer, and wherein a viscosity of the first viscous material is greater than a viscosity of the second viscous material.

16. The display screen as claimed in claim 15, wherein the middle layer of the reinforcing plate adhesive layer structure is a hard polyethylene terephthalate (PET) material.

17. The display screen as claimed in claim 15, wherein a pressure sensitive adhesive material is adopted on both ends the first viscous adhesive layer and the second viscous adhesive layer, and a hard PET material is adopted on the middles of the first viscous adhesive layer and the second viscous adhesive layer.

18. The display screen as claimed in claim 15, wherein a pressure sensitive adhesive material is adopted on both ends the first viscous adhesive layer and the second viscous adhesive layer, and the second viscous material is adopted on the middles of the first viscous adhesive layer and the second viscous adhesive layer.

19. The display screen as claimed in claim 15, wherein pressure sensitive adhesive materials are spaced apart from each other on the first viscous adhesive layer and the second viscous adhesive layer, and the second viscous material is disposed between the pressure sensitive adhesive materials.

20. The display screen as claimed in claim 15, wherein a heat sensitive adhesive material is adopted on both ends and the middles of the first viscous adhesive layer and the second viscous adhesive layer.
